(19) United States
(12) Patent Application Publication
(10) Pub. No.: US 2025/0131414 A1
(43) Pub. Date: Apr. 24, 2025

(54) PAYMENT CARD AND METHOD

(71) Applicant: COOL PARTNERSHIP LiMITED, Northwich (GB)

(72) Inventor: Michael RYAN, Weaverham, Northwich (GB)

(21) Appl. No.: 18/837,384

(22) PCT Filed: Jan. 31, 2023
(86) PCT No.: PCT/GB2023/050215

§ 371 Date: Aug. 9, 2024

(30) Foreign Application Priority Data
Feb. 10, 2022 (GB) 2201753.7

(51) Int. Cl. G06Q 20/34; G06Q 20/38; G07F 7/08

(52) U.S. Cl. CPC G06Q 20/3563; G06Q 20/3433; G06Q 20/349; G06Q 20/383; G07F 7/0833; G07F 7/0846

(57) ABSTRACT

Disclosed herein is a payment device. The payment device comprises a secure element, a microcontroller, a power harvesting module and a display. The secure element is configured to communicate with a merchant terminal to perform a transaction. The payment device is configured to use power obtained from the transaction via the power harvesting module to power the microcontroller and the display. The microcontroller is configured to store a balance value, and to obtain information relating to the transaction from the secure element. The microcontroller is configured to obtain and display an updated balance value on the display based on the obtained information relating to the transaction.

### FIELD OF THE INVENTION

The present disclosure relates to a payment card and method.

### BACKGROUND

Economies across the world are now moving quickly towards the inevitable use of digital cash and the replacement of physical or paper fiat cash. For larger payments (for example above a contactless payment option) there are a plethora of solutions already in place and more options are coming into place.

However, almost all sovereign Treasuries, National Banks, and governments, acknowledge and accept that there remains and probably will remain for the foreseeable future, a need for physical cash, as it is used today. Without a true digital replacement for Fiat cash, a central bank digital currency (CBDC) cannot fully function for all people either efficiently or socially.

Physical fiat cash still does not have a comprehensive or desirable digital replacement. The few CBDCs in operation and the majority of sovereign state economies who are still reviewing the CBDC options, do not have a true solution that replaces all the characteristics and qualities of paper (or polymer) cash. Such as the traditional £20 note, collar bill or euro. etc. Without a true solution the transition to digital currency cannot fully work and many people will suffer.

Research confirms overwhelming percentages of movement from cash usage to digital via debit and credit cards and phone apps across the world. It also shows that a significant percentage of debit card users would prefer the management control and anonymity etc of cash if they could also use that in a digital form.

### SUMMARY OF THE INVENTION

Aspects of the invention are as set out in the independent claims and optional features are set out in the dependent claims. Aspects of the invention may be provided in conjunction with each other and features of one aspect may be applied to other aspects.

In a first aspect there is provided a payment device. The payment device comprises a secure element, a microcontroller, a power harvesting module and a display. The secure element is configured to communicate with a merchant terminal to perform a transaction. The payment device is configured to use power obtained from the transaction via the power harvesting module to power the microcontroller and the display. The microcontroller is configured to store a balance value, and to obtain information relating to the transaction from the secure element. The microcontroller is configured to obtain and display an updated balance value on the display based on the obtained information relating to the transaction.

Advantageously, embodiments of the disclosure may provide a digital solution to fiat cash. The payment device may be linked to a unique (anonymous) account (for example by an issuing authority) where money is held. Thereby no actual money is held on the payment device. The display displays an indication of the money held in the account. this means that the holder can see exactly how much cash they have, without third party reference. It does not require any personal bank account, and thereby works for those that are un-bankable and unbanked, such as children. Effectively, the payment device can act as a cash wallet or purse. It can be passed from person to person when required instead of cash. No internet connection is required. Because the payment device is linked to a unique account, it may still be controlled by a government Treasury and is therefore safe.

The microcontroller may be configured to communicate with the secure element to obtain information relating to the transaction.

The secure element may be configured to store information relating to a balance value held in an account linked to the payment device, and wherein the microcontroller is configured to communicate with the secure element to obtain a balance value held in the account linked to the payment device. This may only work when the merchant terminal is online at time of transaction.

The secure element may be configured to store the value of the transaction, and wherein the microcontroller is configured to store a balance value, communicate with the secure element to obtain the value of the transaction from the information relating to the transaction, and update the balance value based on the difference between the stored balance value and the value of the transaction.

The microcontroller may be configured to determine that a transaction has taken place, and trigger communication with the secure element in response to a transaction having taken place to obtain at least one of (i) the value of the transaction, and (ii) a balance value held in an account linked to the payment device.

The microcontroller may be configured to communication with the secure element via a communication protocol according to at least one of ISO-7816 and EMV standards. Advantageously, this means that the payment device may be used like a conventional debit or credit card. This means that merchants do not need any additional equipment or infrastructure to process these payments.

The payment device may comprise a wireless communications interface coupled to the microcontroller. For example, a near field communication (NFC) interface. The wireless communications interface may be configured to communicate with a remote device, such as an app running on a mobile device or tablet, and/or an ATM. The microcontroller may be configured to communicate with a remote device via the wireless communications interface to obtain a balance value held in an account linked to the payment device. This may be useful to check that the balance displayed by the payment device accurately reflects the balance in the account linked to the payment device.

The independent wireless communications interface can also enable a low-cost “entry level” payment device without a display. An app on a smartphone or other similar device can retrieve the balance from the payment device and present it to a user. In this case, the required energy will be retrieved or harvested from the interaction with the phone, rather than from a merchant terminal.

The microcontroller may be configured to update the balance value displayed by the microcontroller in the event that there is a difference in the balance value stored in the microcontroller and held in the account. In such examples, the remote device may be configured to provoke an alert if the balance value stored on microcontroller and the balance value held in account differ. This may happen, for example, if a transaction was initiated but failed and/or was declined. In some examples the microcontroller may be configured to receive an update command from the remote device so that it may update the balance value stored in the microcontroller memory.

The microcontroller may be configured to receive information from a merchant payment terminal via the secure element relating to at least one of (i) the value of the transaction, and (ii) a balance value held in an account linked to the payment device.

The display may be a bi-stable display, for example an alphanumeric display such as an eInk or ePaper display. Such a display may display information such as a value without requiring any energy; instead energy may only be needed to provoke a change in display.

The microcontroller may comprise a memory and may be configured to store a balance value in the memory. The memory may be a secure memory.

The microcontroller may be a low energy 32-bit controller.

The power harvesting module may be configured to harvest and accumulate energy from a contact or contactless transaction.

The payment device may further comprise a contact plate interface for communicating via a physical connection with a merchant payment terminal.

The secure element may comply with ISO-7816 and its contact lines are multiplexed between the device's contact plate and microcontroller.

The payment device may be a payment card, and/or a wearable item such as a bracelet or necklace.

In another aspect there is provided a computer-implemented method of performing an anonymous transaction. The method comprises communicating with a merchant terminal via a secure element to perform a transaction. Responsive to the transaction having taken place, the method comprises interrogating the secure element to obtain information relating to the transaction.

The method may further comprise storing a balance value and updating the balance value based on the value of the transaction obtained from the information relating to the transaction.

The method may further comprise storing a balance value and updating the balance value based on the balance value of a linked account obtained from the information relating to the transaction.

The method may further comprise displaying a balance value on a display based on the obtained information relating to the transaction.

The method may further comprise determining that a transaction has taken place based on at least one of:
(i) harvesting power from the transaction (either via contact with a merchant termina (VIA ISO 7816) or via a contactless interaction with a merchant terminal); or
(ii) by initiating an interaction with the microcontroller e.g., via a communications interface such as a wireless communications interface such as an NFC interface from a remote device such as a mobile device, tablet etc. In this case the microcontroller may determine that a transaction has taken place due to energy harvested from the interaction with the remote device.

In another aspect there is provided a computer implemented method of communicating with a payment device. The method comprises communicating with a payment device to obtain an indicating of a balance value from the payment device stored on the payment device, determining the actual balance value of an account linked to the payment device, and providing an alert to a user if the actual balance value of the account linked to the payment device and the balance value stored on the payment device differ and/or updating the balance value stored on the payment device in the event that the balance value stored on the payment device and the actual balance value differ.

In another aspect there is provided a computer readable non-transitory storage medium comprising a program for a computer configured to cause a processor to perform the method of the aspects described above.

### DRAWINGS

Embodiments of the disclosure will now be described, by way of example only, with reference to the accompanying drawings, in which:

FIG. 1 shows a functional schematic diagram of how a conventional payment device such as a payment card works and interacts with a merchant terminal when paying for goods or services in the United Kingdom;

FIG. 2 shows a functional schematic diagram of an example payment device which in this example is a payment card;

FIG. 3 shows a functional flow chart of an example method of using a payment device at a merchant terminal, where the payment device is only temporarily in proximity with the merchant terminal and/or wherein the merchant terminal is offline at the time of performing a transaction;

FIG. 4 shows a functional flow chart of another example method of using a payment device at a merchant terminal, for example where the payment device is in physical contact with the merchant terminal (e.g. “chip and pin”) or held in physical proximity for an extended period of time, and wherein the merchant terminal is online at the time of performing a transaction;

FIG. 5 shows a sequence diagram for information flow between a payment device and a merchant terminal, where the payment device is only temporarily in proximity with the merchant terminal and/or wherein the merchant terminal is offline at the time of performing a transaction, for example in accordance with the example method of FIG. 3; and

FIG. 6 shows a sequence diagram for information flow between a payment device and a merchant terminal, where the payment device is in physical contact with the merchant terminal (e.g. “chip and pin”) or held in physical proximity for an extended period of time, for example in accordance with the example method of FIG. 4.

### SPECIFIC DESCRIPTION

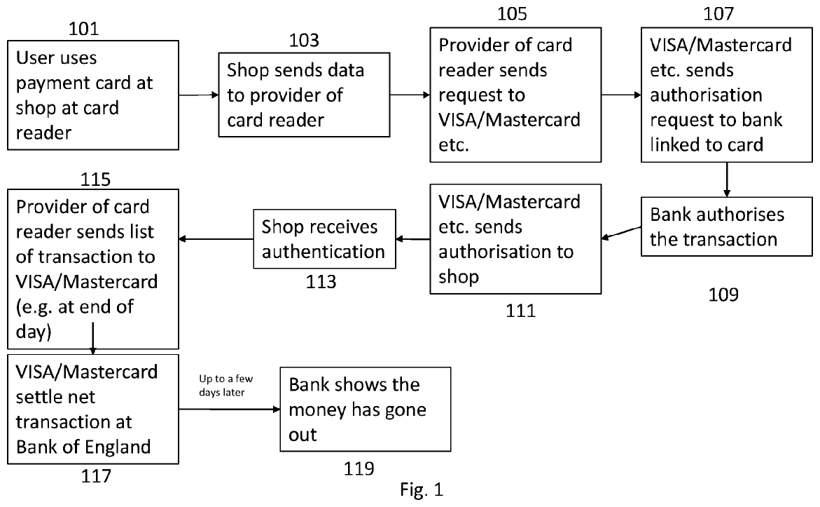

FIG. 1 is a functional schematic diagram of how a conventional payment device such as a payment card works and interacts with a merchant terminal when paying for goods or services in the United Kingdom. A similar principle of operation may work in other countries with their national banks instead of the Bank of England.

At step 101 a user uses a payment device such as a payment card at a shop. The user presents their payment device (either wirelessly via contactless payment, or via physical contact via chip and pin) to the merchant terminal which may be a card reader. The merchant terminal communicates with the payment device (more particularly, with the secure element (SE) of the payment device which will be discussed in more detail below). At step 103 the merchant terminal sends data to the provider of the merchant terminal. At step 105, the provider of the merchant terminal sends a request to a payment network (such as MasterCard®, VISA® etc.). At step 107, the payment network sends an authorisation request to a bank (i.e., a bank account linked to the payment device). At step 109 the bank authorises (or declines) the transaction. At step 111 a payment network (such as MasterCard®, VISA® etc.) sends an authorisation to the merchant terminal in the shop. The merchant terminal in the shop receives this authentication at step 113 and the user has completed their transaction with the shop. However, at this stage no money has transferred between the bank linked to the payment device/card and the shop's bank. Typically, once a day, such as at the end of the day, the provider of the merchant terminal sends a list of transactions for that day (both from that shop but also from other merchant terminals) to the payment network (such as MasterCard®, VISA® etc.). The payment network (such as MasterCard®, VISA® etc.) then settles net transactions with the shop's banks typically with a net transaction at the Bank of England at step 117. At some point later, which may be a few days later, the bank then shows at step 119 that the money has left the bank account.

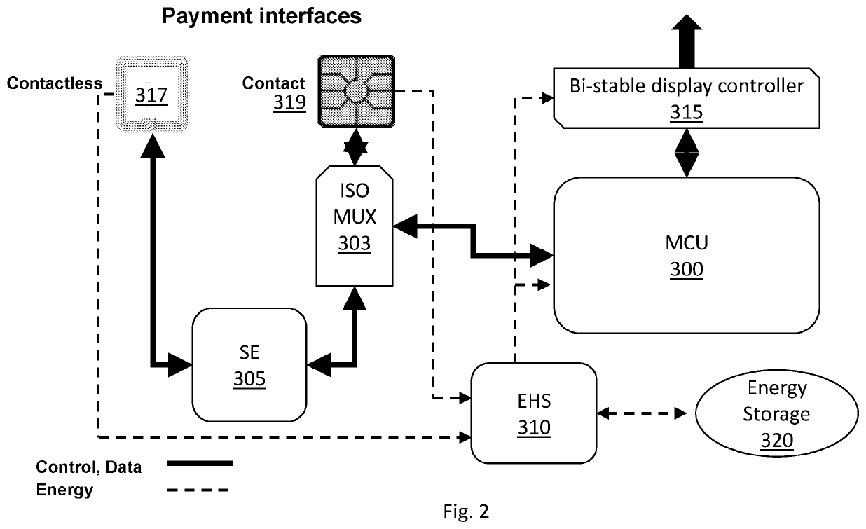

FIG. 2 is a functional schematic diagram of an example payment device which in this example is a payment card. In this example the payment card has a form factor that is the same as a regular credit or debit card (i.e. 85.60 by 53.98 millimetres with rounded corners with a radius of 2.88-3.48 millimetres conforming to the ISO/IEC 7810 ID-1 standard. However, it will be understood that the functionality displayed in FIG. 2 may have a different form factor, for example it may be integrated into a wearable device such as a bracelet or necklace. In this example the payment device is EMV® (Europay®, MasterCard®, and Visa®) compliant. The payment device may comply with ISO/IEC 7816 and/or ISO/IEC 14443. The payment device comprises an EMV® contact interface 319 and a contactless antenna 317, both coupled in parallel to a secure element (SE) 305.

The SE 305 is a microprocessor chip which can store sensitive data and run secure apps such as payment. It acts as a vault, protecting what's inside the SE (applications and data) from malware attacks that are typical in the host (i.e., the device operating system). Applications may use the SE 305 to digitally sign data with a key stored in this secure element. This key helps the secure element unlock encrypted data so it can be read. The SE 305 securely stores card/cardholder data and manages the reading of encrypted data. During a payment transaction it uses industry standard technology to help authorize a transaction. The SE 305 when used in other payment devices other than a payment card could for example be embedded in a phone or subscriber identification module (SIM) card. The SE 305 can be implemented in payment devices in one of several ways: as a removable device—for example, in a universal integrated circuit card (UICC) (also known as a SIM card) or in a Micro SD card; as an embedded SE (eSE); and/or as a cloud service. The SE 305 may provide the following features at the hardware level:
Detection of hacking and modification attempts;
Creation of a Root of Trust (RoT) platform for encryption systems;
Provision of secure memory for storing private encryption keys, bank card details, and other information;
Cryptographically secure generation of random numbers;
Generation of keys—for example, pairs of private and public keys for asymmetric encryption.

The SE 305 may comprise a Java Card Operating System (OS), and a payment applet.

In the example shown the SE 305 is coupled to the contact interface 319 via an ISO multiplexer (MUX) 303. The ISO multiplexer 303 is also coupled to a microcontroller (MCU) 300. The ISO MUX 303 is configured to provide access to the SE 305 for the MCU 300 The ISO MUX 303 multiplexes the contact lines between the contact interface 319 and MCU 300 and may be configured to arbitrate between the SE 305 and the MCU 300.

The MCU 300 is configured to communication with the SE 305 via a communication protocol according to at least one of ISO-7816 and EMV® standards. The MCU 300 may comprise or be coupled to a memory, which may be a secure memory. The MCU 300 may be a low energy 32-bit controller.

The MCU 300 is coupled to a display which may be referred to as a card value display (CVD), and in this example is a bi-stable display 315. Although other displays may be used, preferably the display is a low power display such as ePaper or eInk. A bi-stable display is advantageous as it does not require power to maintain the display, power is only used to change the display. In this example the bi-stable display 315 is an alphanumeric display and comprises a bi-stable controller configured to communicate with and receive instruction from the MCU 300 to display a value. The MCU 300 is configured to receive information from a merchant payment terminal via the SE 305 relating to at least one of (i) the value of the transaction, and (ii) a balance value held in an account linked to the payment device/SE 305.

The payment device in this example also comprises a power harvesting module in the form of an energy harvesting system (EHS) 310 configured to harvest energy from an interaction of the payment device with a payment/merchant terminal. For example, the EHS 310 is configured to harvest and accumulate energy from a contact or contactless transaction with a merchant terminal. The EHS 310 may be available from, e.g., Freevolt™ and may be a radio frequency energy harvesting system. In this example the EHS 310 is coupled to both the EMV contact interface 319 and the contactless antenna 317. The EHS 310 is also coupled to an energy storage 320 which may be in the form of a battery or capacitor and is configured to store energy captured by the EHS 310.

The EHS 310 is coupled to the MCU 300 and the bi-stable display 315 and is configured to provide power to the MCU 300 and the bi-stable display 315.

The SE 305 is configured to communicate with a merchant terminal to perform a transaction. The payment device is configured to use power obtained from the transaction via the energy harvesting system 310 to power the MCU 300 and the display 315. The MCU 300 may comprise a memory, and is configured to store a balance value, and to obtain information relating to the transaction from the SE 305. The MCU 300 memory may be secure, being electronically sealed and protected. The MCU 300 is configured to obtain and display an updated balance value on the display 315 based on the obtained information relating to the transaction obtained from the SE 305. The MCU 300 is configured to communicate with the SE 305 to obtain information relating to the transaction.

The MCU 300 may be configured to communication with the SE 305 by running a virtual or “spoof” transaction. The MCU 300 may be configured to connect with the SE 305 and behave like a merchant terminal, communicating with the SE 305 using the same standards (such as ISO-7816 and EMVR). The communication between the MCU 300 and the SE 305 may comprise a series of command-response messages. These may comprise commands such as “do you have a last transaction value”, “tell me the value of the previous transaction” or “tell me the value of the balance held in the account linked to this SE”. In some examples this may require adaption of the service layer of the SE 305 to provide this functionality.

In some examples, the SE 305 is configured to store information relating to a balance value held in an account linked to the payment device. In such examples the MCU 300 may be configured to communicate with the SE 305 to obtain a balance value held in the account linked to the payment device. However, this may only work then the merchant terminal is online at the time of the transaction, and/or when the payment device is in communication with (for example in range of the contactless interface 317 or coupled via the contact interface 319) the merchant terminal.

Additionally, or alternatively, the SE 305 is configured to store the value of the transaction (for example, the SE 305 is configured to store the value of the transaction when communicating with the merchant terminal via at least one of the contactless interface 317 and the contact interface 319). In such examples, the MCU 300 may be configured to store a balance value, communicate with the SE 305 to obtain the value of the transaction from the information relating to the transaction, and update the balance value based on the difference between the stored balance value and the value of the transaction.

In some examples, the MCU 300 is configured to determine that a transaction has taken place, and trigger communication with the SE 305 in response to a transaction having taken place to obtain at least one of (i) the value of the transaction, and (ii) a balance value held in an account linked to the payment device. Waiting until after the transaction has taken place advantageously means that the SE 305 is only communicating with one entity (merchant terminal, MCU 300) at a time. Because the MCU 300 communicates with the SE 305, this means that it is only the SE 305 that communicates with the “outer world” thereby ensuring that the payment device remains secure.

The MCU 300 may be configured to determine that a transaction has taken place for example by receiving an indication from the EHS 310 that it has received energy (e.g., from the transaction), for example above a selected threshold level of energy. In some examples, the MCU 300 may be configured to switch between two modes of operation in response to a transaction having taken place; for example a first “sleep” mode when a transaction has not taken place for more than a selected threshold period of time, and a second “awake” mode of operation in response to a transaction having taken place. In some examples the MCU 300 may be configured to return to the first “sleep” mode of operation in response to the MCU 300 having updated the balance value on the display 315, and/or in response to a selected threshold period of time having elapsed.

In some examples the MCU 300 is configured to communicate with a remote device via the wireless communications interface 317 and/or an additional wireless communications interface (such as an NFC interface) to obtain a balance value held in an account linked to the payment device. The remote device may, for example, by a mobile device such as a smartphone or tablet device.

The MCU 300 is configured to update the balance value displayed by the MCU 300 on display 315 (and held by the MCU 300 memory) in the event that there is a difference in the balance value stored by the MCU 300 and held in the account. In some examples, the remote device may be configured to provoke an alert if the balance value stored on the MCU 300 and the balance value held in the account differ.

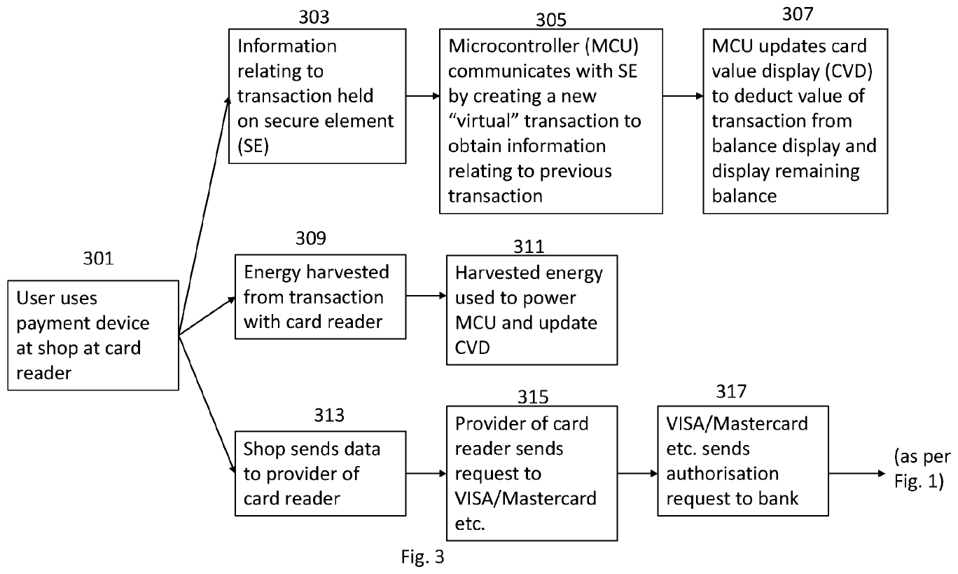

FIG. 3 is a functional flow chart of an example method of using a payment device such as the payment device of FIG. 2 at a merchant terminal, the payment device comprising a display, a microcontroller and a secure element, and a merchant terminal, where the payment device is only temporarily in proximity with the merchant terminal and/or wherein the merchant terminal is offline at the time of performing a transaction.

The method begins at step 201 where the user uses the payment device which in this example is a payment card at a shop at a merchant terminal which in this example is a card reader. Here the SE 305 of the payment card interacts with the merchant terminal to share information securely with the merchant terminal. At step 213 the merchant terminal in the shop sends data to the provider of the card reader. The provider of the card reader then sends a request to a payment network (such as VISA®, MasterCard® etc.) at step 215, and the payment network sends a request at step 217 to the bank. The method then continues as described above in FIG. 1.

At the time when the card is being used with the card reader (i.e. at step 201), the interaction between the card and the card reader uses energy which is harvested at step 209 by the payment card (such as by the EHS 310). This harvested energy is used at step 211 to power the MCU 300. The MCU 300, in response to this power being harvested, wakes up and initiates a communication at step 203 with the SE 305. The MCU 300 communicates with the SE 305 by creating a new “virtual” transaction, using ISO-7816 and EMV standards, to obtain information relating to the value of the transaction from the SE 305 at step 205. At step 207 the MCU 300 then uses the obtained value of the transaction from the SE 305 to update the value held in its memory and displayed on the display 315.

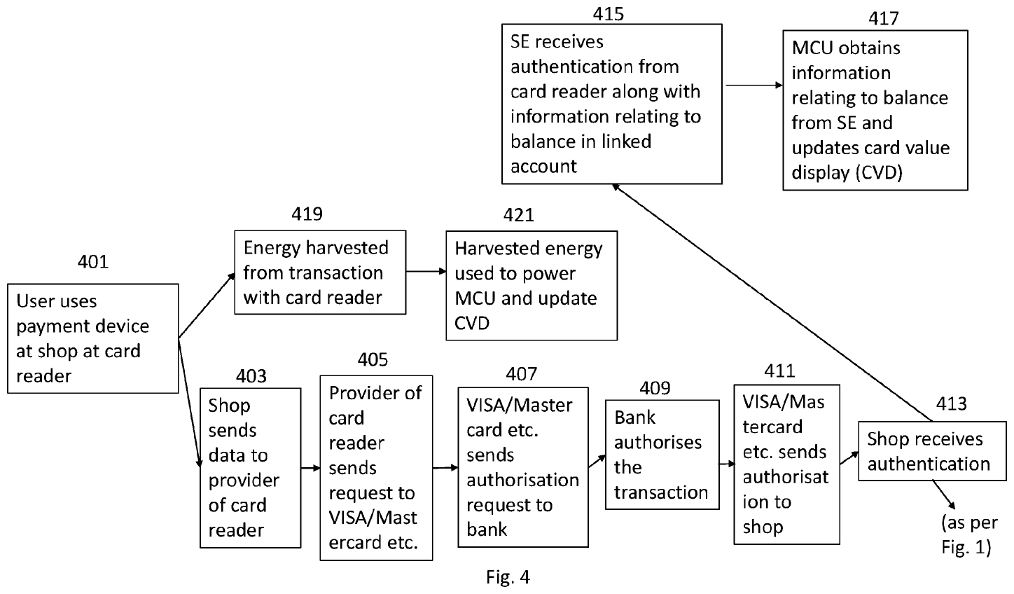

FIG. 4 is a functional flow chart of another example method of using a payment device at a merchant terminal, for example where the payment device is in physical contact with the merchant terminal (e.g. “chip and pin”) or held in physical proximity for an extended period of time, and wherein the merchant terminal is online at the time of performing a transaction, such that the payment device is able to obtain information relating to whether the transaction was successful and/or the balance of an account associated with the payment device from the merchant terminal. The method shown in FIG. 4 shares many similarities with the method shown in FIG. 3, apart from in FIG. 4 the MCU 300 waits until authentication of the transaction has been received by the merchant terminal and received by the MCU 300 before updating the balance value held in the memory and displayed on the display 315. This may advantageously ensure the value displayed on the payment device accurately reflects the true value held and addresses issues where the transaction may have been declined or where the merchant terminal was offline at the time of the transaction.

The method begins at step 401 where the user uses the payment device which in this example is a payment card at a shop at a merchant terminal which in this example is a card reader. Here the SE 305 of the payment card interacts with the merchant terminal to share information securely with the merchant terminal. At step 403 the merchant terminal in the shop sends data to the provider of the card reader. The provider of the card reader then sends a request to a payment network (such as VISA®, MasterCard® etc.) at step 405, and the payment network sends a request at step 407 to the bank. The bank authorises the request at step 409 and the payment network sends the authorisation to the shop/merchant terminal at step 411 and it is received by the shop/merchant terminal at step 413. The method then continues as described above in FIG. 1.

At the time when the card is being used with the card reader (i.e. at step 501), the interaction between the card and the card reader uses energy which is harvested at step 419 by the payment card (such as by the EHS 310). This harvested energy is used at step 421 to power the MCU 300.

However, in this instance, the MCU 300, waits until authorisation has been received by the SE 305 before initiating communication at step 415 with the SE 305. The MCU 300 communicates with the SE 305 by creating a new “virtual” transaction, using ISO-7816 and EMV standards, to obtain at least one of information relating to the value of the transaction from the SE 305 and the value of an account balance linked to the payment device. At step 417 the MCU 300 then uses the obtained value of the transaction from the SE 305 to update the value held in its memory and displayed on the display 315.

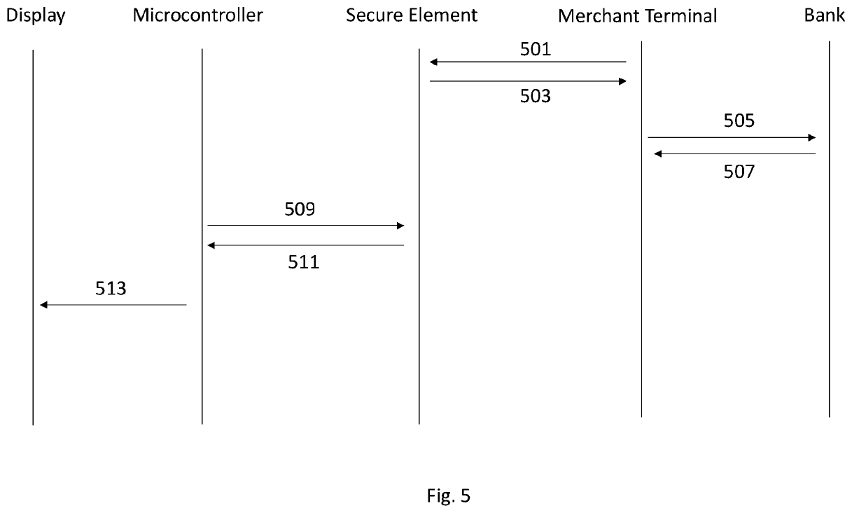

FIG. 5 shows a sequence diagram for information flow between a payment device comprising a display, a microcontroller and a secure element, and a merchant terminal, where the payment device is only temporarily in proximity with the merchant terminal and/or wherein the merchant terminal is offline at the time of performing a transaction, for example in accordance with the example method of FIG. 3.

The process begins with the user presenting the payment device to the merchant terminal. The merchant terminal communicates 501 with the SE 305 of the payment device to initiate a transaction and to obtain information from the SE 305. In response, the SE 305 communicates 503 with the SE 305 to send secure data.

Once the merchant terminal has received this information from the SE 305, it is sent 505 by the merchant terminal to a bank/payment provider network (as described above with reference to FIG. 1), and at some point later receives an authorisation (or declination) of the payment when it receives 507 information back.

In parallel to the merchant terminal communicating 505 with the bank/payment provider, the MCU 300 determines that a transaction has taken place, and initiates communication 509 with the SE 305, for example to interrogate the SE 305 to obtain the value of the transaction and/or the balance value of an account linked to the payment device/SE 305. In response, the SE 305 sends 511 information to the MCU 300. The MCU 300 in response sends 513 information to the display 315 to display the new balance value on the display 315. The MCU 300 may also update the balance value held in memory.

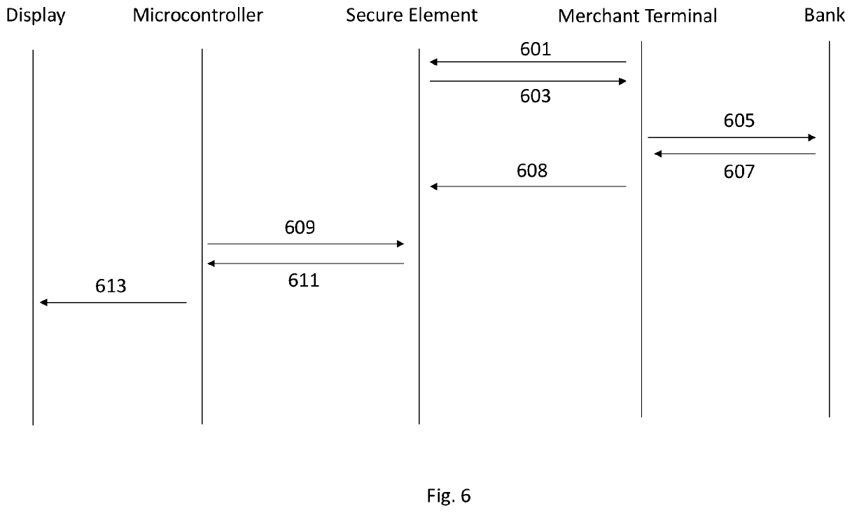

FIG. 6 shows a sequence diagram for information flow between a payment device comprising a display, a microcontroller and a secure element, and a merchant terminal, where the payment device is in physical contact with the merchant terminal (e.g., “chip and pin”) or held in physical proximity for an extended period of time, and wherein the merchant terminal is online at the time of performing a transaction, such that the payment device is able to obtain information relating to whether the transaction was successful and/or the balance of an account associated with the payment device from the merchant terminal, for example in accordance with the example method of FIG. 4.

The process in FIG. 6 is similar to the process described above for FIG. 5, but in this instance the MCU 300 waits until authorisation has been received by the merchant terminal before communicating with the SE 305.

The process begins by the user presenting the payment device to the merchant terminal. The merchant terminal communicates 601 with the SE 305 of the payment device to initiate a transaction and to obtain information from the SE 305. In response, the SE 305 communicates 603 with the SE 305 to send secure data.

Once the merchant terminal has received this information from the SE 305, it is sent 605 by the merchant terminal to a bank/payment provider network (as described above with reference to FIG. 1), and at some point later receives an authorisation (or declination) of the payment when it receives 607 information relating to the transaction (e.g. authorised, declined) back.

In response to the merchant terminal receiving 607 information relating to the transaction from the bank/payment provider, the merchant terminal sends 608 information back to the SE 305 including information relating to the transaction (e.g., value of transaction, approved/declined and/or remaining balance in account linked to payment device/SE 305).

In response to the SE 305 receiving 608 this information, the MCU 300 determines that a transaction has taken place, and initiates communication 609 with the SE 305, for example to interrogate the SE 305 to obtain the value of the transaction and/or the balance value of an account linked to the payment device/SE 305. In response, the SE 305 sends 611 information to the MCU 300. The MCU 300 in response sends 613 information to the display 315 to display the new balance value on the display 315. The MCU 300 may also update the balance value held in memory.

Also described herein is a computer-implemented method of communicating with a payment device. The method may be performed, for example, by a remote device such as a smartphone or tablet, for example to check the balance held by a payment device (more specifically, in an account uniquely linked to the payment device) and/or to add funds to the payment device (more specifically, to an account uniquely linked to the payment device). The method comprises communicating with a payment device to obtain an indicating of a balance value from the payment device stored on the payment device, determining the actual balance value of an account linked to the payment device, and providing an alert to a user if the actual balance value of the account linked to the payment device and the balance value stored on the payment device differ and/or updating the balance value stored on the payment device in the event that the balance value stored on the payment device and the actual balance value differ.

When cash is withdrawn onto the payment device, say from an ATM or similar, a unique bank account number may be generated for that payment device e.g., that is linked to that payment device. The unique bank account number may be extinguished when the payment device is empty of funds or value and will therefore be ready for a new unique bank account number to be allocated (i.e., wallet or account is closed when emptied).

To withdraw funds using the payment device, a person would continue in the same way, to withdraw cash from their bank, employer, institution, ATM and so on. Cash will however be digital in the form of the payment device, with its value displayed in eInk or similar ePaper. A maximum limit may be placed on the amount allocated to each payment device.

The payment device should be returned when empty or diminished where possible. ATM or any issuer will collect the used payment device. When placed in an ATM or bank, it will be wiped clean of its bank identity number. The payment device may then be held there until a withdrawal is activated when it will be issued with a new concealed unique identification/code (wallet or bank account). The requested value placed in its individual account, displayed on the payment device as the fresh payment device (reused) issued.

The payment device cash withdrawal process is the same as physical cash is today. The payment device, if it is in the form of a payment card for example, may be placed into the merchant's card reader or ATM and the user invited to type the requested amount of cash. The payment device is issued fresh with a new unique identification number/code and value each time it is reissued and withdrawn.

The account withdrawing and therefore funding the wallet or bank account may be charged a nominal fee. The holder of the payment device is not charged, just as with physical cash.

The wallet/bank account may be configured to expire, and any retained funds returned to the bank as a windfall, after a period, say 5 years, for example if the account has not been activated in that time.

The methods described herein may be realized in digital electronic circuitry, integrated circuitry, specially designed ASICs (application specific integrated circuits), computer hardware, firmware, software, and/or combinations thereof. These systems, devices, and techniques may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, or code) may include machine instructions for a programmable processor and may be implemented in a high-level procedural and/or object-oriented programming language, and/or in assembly/machine language. As used herein, the terms “machine-readable medium” and “computer-readable medium” refer to any computer program product, apparatus, and/or device (such as magnetic discs, optical disks, memory, or Programmable Logic Devices (PLDs)) used to provide machine instructions and/or data to a programmable processor.

Examples of remote devices may include, but are not limited to, mobile devices, smartphones/cellphones, wearable device (e.g., smartwatches), tablets, personal digital assistants (PDAs), laptop or notebook computers, desktop computers, media content players, television sets, video gaming station/system, virtual reality systems, augmented reality systems, microphones, or any electronic device capable of analyzing, receiving (e.g., receiving user input in one or more fields in a form, receiving definition of rules associated with a page, etc.), providing or displaying certain types of data (e.g., system generated personalization parameter options, original document, derivative document, etc.) to a user. The remote device may be a handheld object. The remote device may be portable. The remote device may be carried by a human user. In some cases, the user device may be located remotely from a human user, and the user can control the user device using wireless and/or wired communications. The remote device can be any electronic device with a display.

As utilized herein, terms “component,” “module,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

In the context of the present disclosure other examples and variations of the apparatus and methods described herein will be apparent to a person of skill in the art. It will be appreciated from the discussion above that the embodiments shown in the Figures are merely exemplary, and include features which may be generalised, removed or replaced as described herein and as set out in the claims.

1. A payment device, comprising:
a secure element;
a microcontroller;
a power harvesting module; and
a display;
wherein the secure element is configured to communicate with a merchant terminal to perform a transaction;
the payment device is configured to use power obtained from the transaction via the power harvesting module to power the microcontroller and the display;
the microcontroller is configured to store a balance value, and to obtain information relating to the transaction from the secure element; and
the microcontroller is configured to obtain and display an updated balance value on the display based on the obtained information relating to the transaction.

2. The payment device of claim 1, wherein the microcontroller is configured to communicate with the secure element to obtain information relating to the transaction.

3. The payment device of claim 1, wherein the secure element is configured to store information relating to a balance value held in an account linked to the payment device, and wherein the microcontroller is configured to communicate with the secure element to obtain a balance value held in the account linked to the payment device.

4. The payment device of claim 2, wherein the secure element is configured to store the value of the transaction, and wherein the microcontroller is configured to store a balance value, communicate with the secure element to obtain the value of the transaction from the information relating to the transaction, and update the balance value based on the difference between the stored balance value and the value of the transaction.

5. The payment device of any of claim 2, wherein the microcontroller is configured to determine that a transaction has taken place, and trigger communication with the secure element in response to a transaction having taken place to obtain at least one of (i) the value of the transaction, and (ii) a balance value held in an account linked to the payment device,
wherein the microcontroller is configured to communication with the secure element via a communication protocol according to at least one of ISO-7816 and EMV standards.

6. (canceled)

7. The payment device of claim 1, wherein the payment device comprises a wireless communications interface coupled to the microcontroller,
wherein the microcontroller is configured to communicate with a remote device via the wireless communications interface to obtain a balance value held in an account linked to the payment device.

8. (canceled)

9. The payment device of claim 3, wherein the microcontroller is configured to update the balance value displayed by the microcontroller in the event that there is a difference in the balance value stored in the microcontroller and held in the account.

10. The payment device of claim 1, wherein the microcontroller is configured to receive information from a merchant payment terminal via the secure element relating to at least one of (i) the value of the transaction, and (ii) a balance value held in an account linked to the payment device.

11. The payment device of claim 1, wherein the display is a bi-stable display.

12. The payment device of claim 1, wherein the microcontroller comprises a memory and is configured to store a balance value in the memory.

13. The payment device of claim 1, wherein the microcontroller is a low energy 32-bit controller.

14. The payment device of any of the previous claim 1, wherein the power harvesting module is configured to harvest and accumulate energy from a contact or contactless transaction.

15. The payment device of claim 1, further comprising a contact plate interface for communicating via a physical connection with a merchant payment terminal, w
herein the secure element complies with ISO-7816 and its contact lines are multiplexed between the device's contact plate and microcontroller.

16. (canceled)

17. The payment device of claim 1, wherein the payment device is a payment card or is a wearable item.

18. (canceled)

19. A computer-implemented method of performing an anonymous transaction, the method comprising:
communicating with a merchant terminal via a secure element to perform a transaction; and
responsive to the transaction having taken place, interrogating the secure element to obtain information relating to the transaction.

20. The computer implemented method of claim 19, further comprising storing a balance value and updating the balance value based on the value of:
(i) the transaction obtained from the information relating to the transaction, and/or
(ii) a linked account obtained from the information relating to the transaction.

21. (canceled)

22. The computer implemented method of claim 20, further comprising displaying a balance value on a display based on the obtained information relating to the transaction.

23. The computer implemented method of claim 19, further comprising determining that a transaction has taken place based on at least one of:
(i) harvesting power from the transaction.

24. A computer implemented method of communicating with a payment device, the method comprising:
communicating with a payment device to obtain an indicating of a balance value from the payment device stored on the payment device;
determining the actual balance value of an account linked to the payment device; and
providing an alert to a user if the actual balance value of the account linked to the payment device and the balance value stored on the payment device differ and/or updating the balance value stored on the payment device in the event that the balance value stored on the payment device and the actual balance value differ.

25. A non-transitory computer readable storage medium comprising program stored thereon that, when executed by a processor, performs the method of claim 19.
